(19) United States
(12) Patent Application Publication
(10) Pub. No.: US 2012/0171456 A1
(43) Pub. Date: Jul. 5, 2012

(54) PRESSED LAMINAR SHEET COMPRISING A RETICULAR ROOT MAT AND ADHESIVE, METHOD THEREOF AND WOOD-LIKE PANEL MADE USING SAID LAMINAR SHEET

(76) Inventors: Ignacio Patricio Zuniga Bravo, Las Condes (CL); Roberto Parcela Garcia Castelblanco, Sector Los Copihue (CL)

(21) Appl. No.: 13/395,281

(22) PCT Filed: Oct. 21, 2009
(86) PCT No.: PCT/CL2009/000017

§ 371 Date: Mar. 9, 2012

(30) Foreign Application Priority Data
Sep. 9, 2009 (CL) 1830-2009

(51) Int. Cl. D04H 13/00; B27N 3/20

(52) U.S. Cl. 428/292.1; 264/257

(57) ABSTRACT

The invention relates to a pressed laminar radicle sheet comprising an extended layer of a reticular mat, originating from a hydroponic seed culture, and sufficient adhesive to form the laminar sheet. The method for the production of said laminar sheet comprises: a) selecting, disinfecting, steeping, airing, sowing and germinating the seeds; b) producing a reticular component formed by a root mat and a low percentage of ungerminated seeds, as well as a leaf component; c) cutting back the leaf growth, leaving only 1 to 1.5 cm height; d) allowing further leaf growth; e) cutting the leaf growth back again, leaving only 1 to 1.5 cm; f) draining, drying and weighing and measuring the reticular mat g) forming the unpressed laminar sheet, adding the adhesive to the reticular mat and pressing said mat with adhesive in a cold press; h) pressing the unpressed laminar sheet with a hot press and leaving said laminar sheet to rest in the cold press. In addition, the invention relates to: the use of a laminar sheet as a substitute for wood in the production of panels, boards, laminar sheets or similar wood-based products; a panel similar to a chipboard panel and the method for the production thereof, said panel comprising the laminar sheet at least a second layer of said laminar sheet and at least one layer of adhesive between the layers of laminar sheet; and a pressed plywood laminar radicle sheet comprising at least one layer of a pressed laminar radicle sheet, at least two layers of some other material and at least one layer of adhesive between the layers.

### TECHNICAL FIELD

The present invention relates to a pressed laminar radicle sheet, the method for the production thereof, products obtained from said pressed laminar sheet, such as panels, boards, laminar sheets, plywood sheets or the like, which present visual characteristics similar to chipboard, and to the procedure for obtaining a panel

### BACKGROUND OF THE INVENTION

The production of chipboard sheets generally comprises: removing the bark from a tree, cutting it into pieces and subsequently reducing their size until obtaining wood chips of 0.2 to 0.4 mm thick, then said wood chips are dried until reaching a moisture between 4% to 6%, impregnated with urea formaldehyde resin, and, sometimes, with melamine formaldehyde, and spread on a metal plate such that they form three layers: two thin external layers based on the finest wood chips and one central layer based on the thicker ones. At the end of this stage, they will be directed to the press. Finally the sheets are cut, polished and stored in a warehouse for a period of 10 days in order to balance their moisture content. Another way of producing these chipboard sheets is by extrusion, which consists of a hydraulic cylinder horizontally pushing the wood particles through the parallel heated metal plates, the separation of which can be adjusted. Thus, a continuous thicker board is obtained, but having an internal structure which is slightly different due to the longitudinal pressure, not vertical, exerted on the particles. The extruded boards have a higher tensile strength and a lower flexural strength.

In both previously described processes are used: wood as raw material, large amounts of water and large machinery and infrastructure. The present invention proposes to replace wood by a pressed laminar radicle sheet, obtained from a reticular mat which is originated from a hydroponic seed culture, thus eliminating the use of large amounts of water and the need for large infrastructure.

### SUMMARY OF THE INVENTION

The invention comprises the formation of pressed laminar radicle sheet and the procedure for the production thereof for which firstly a reticular mat must be obtained. Another object of the present invention is to obtain panels made from laminar radicle sheets and the method thereof. A further object of the invention is to obtain pressed plywood sheets.

### BRIEF DESCRIPTION OF THE DRAWINGS

The invention will be now described in reference to the accompanying drawings, in which:

FIG. 1 is an upper perspective view of a panel formed from four layers of pressed laminar radicle sheet (1).

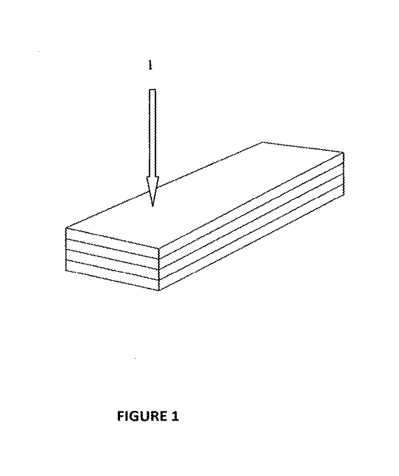

FIG. 2 is an upper perspective view of a pressed plywood laminar radicle sheet, formed from a first layer of plywood (1), a second layer of a pressed laminar radicle sheet (3) and a last layer of plywood (2).

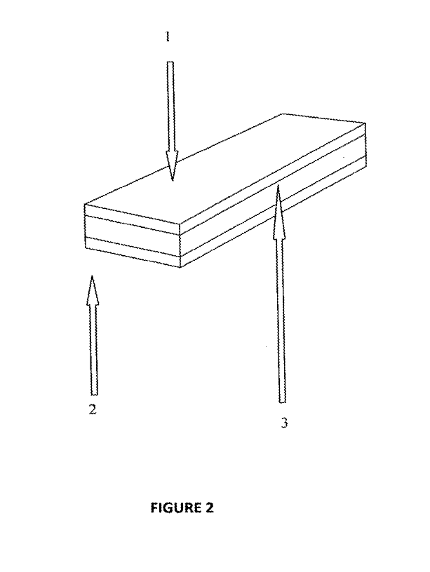

### DETAILED DESCRIPTION OF THE INVENTION

### Obtaining the Reticular Mat

1. Selecting of seeds: First of all the quality of the seeds is checked and for this purpose the level of impurities is determined. This is performed by randomly taking small quantities of seeds from different sacks until completing one kilogram of sample of seeds, then said sample of seeds is immersed in water, agitated and measured so as to know the amount of empty seeds and impurities which remain floating in the water. If the amount of empty seeds and impurities is higher than 20%, the shipment of seeds will be rejected.
2. Disinfecting the seeds: This stage consists in washing the seeds in a bleach solution to 10% during 3 to 5 minutes, rinsing them to remove bleach residues and eliminate the empty seeds and impurities present therein.
3. Steeping: In this stage the seeds are immersed in water during a determined period of time, which will depend on the quality of the seed. In case of having seeds of a very good quality, the steeping time can be reduced, however said time cannot be less than 24 hours or higher than 48 hours. In this stage, the use of fertilizers can be included, if necessary, and it is advisable to properly oxygenate the water or steeping solution.
4. Airing: This stage consists in placing the seeds in tins, leaving them in a dark place. Depending on the quality of the seed, this process will take 24 to 72 hours. The tin containing the seeds must be well aired.
5. Sowing and germinating: In this stage the seeds are arranged in trays appropriate for sowing and moved to a dark room to simulate the dark conditions of the soil. Once in this module they are kept for at least 2 days, with at least 1 watering during this period, the duration of which varies from one to 4 minutes. This variation will depend on the available room temperature and whether is winter or summer. If a bigger radicle growth is desired in this stage, it is advisable to provide a water stress, which consists in not watering the seeds such that a bigger radicle growth is induced, due to the simulation of a state of drought.
6. Producing: In this stage the germinated seeds are moved into the light, watered 2 to 3 times per day, uniformly distributed during the day and with enough water in order to maintain the moisture of the culture. This stage has an average duration of 8 to 15 days, depending on the development of the plant and the season of the year. In this stage, if necessary, the use of fertilizers can be included. A block is obtained as a product which has two main components:
   Leaf Component which corresponds to a green matter in the form of leaves with an approximate length of 10 to 20 cm height.
   Reticular component, root mat and ungerminated seeds of approximately 3 to 5 cm height.
   The production process continues by cutting back the leaf growth, leaving only 1 to 1.5 cm height of the leaf growth on the reticular mat, thus a second stage of production begins, which lasts in average 4 to 8 days and where the operational conditions are the same as the ones previously described. This second stage of production allows to obtain a reticular mat having a lower percentage of ungerminated seeds.
   The dimensions of the obtained block will depend on the size of the tray used in the germination process, for example, in trays of 62 cm length, 41 cm width and 10 cm height, the obtained blocks have dimensions of approximately 60 cm length, 40 cm width and 25 cm height and with an approximate weight of 5 to 7 kilograms.

Obtaining the Pressed Laminar Radicle Sheet
1. Cutting back the leaf growth: The leaf growth of the obtained block is cut back, leaving only 1 to 1.5 cm of leaf growth on the reticular mat.
2. Draining: The reticular mat is drained, preferably, by leaving it to rest at least one hour on a grid to naturally eliminate the water. Possibly, this can also be centrifuged for at least 1 minute, wherein another part of water and part of the ungerminated seeds are eliminated as well.
3. Drying: In this stage the reticular mat is slowly dried for at least 12 hours in order to obtain a reticular mat with approximately 10% of moisture, preferably, 10% of moisture. Once the drying stage is finished, the reticular mat is weighed and measured.
4. Application of the adhesive: The quantity of adhesive to be applied to the dried reticular mat will depend on the weight and/or volume thereof and/or on the indications of the adhesive manufacturer. As the reticular mat is a porous body, it should be considered to apply twice the amount indicated by the manufacturer per square meter. The adhesive is applied to the reticular mat, ensuring that said adhesive penetrates the interstices of the reticular mat in the best possible way. In order to adequately spread the adhesive within the interstices of the reticular mat, said mat is pressed with the adhesive in a cold press for not more than 1 minute so as to promote the penetration of the adhesive within the sheet. Once this application is finished, an unpressed laminar radicle sheet is obtained.
5. Pressing: The unpressed laminar radicle sheet is pressed with a hot press at a temperature of approximately 40° C. to 100° C. for at least 3 minutes. Subsequently, it is left to rest in a cold press for the stabilization thereof, for at least 7 days.
   After finishing the process, a pressed laminar radicle sheet is obtained, being this sheet visually similar to chipboard with a thickness of at least 4 millimeters. The obtained product is worked according to the desired dimensions and serves as substitute for wood in the manufacture of panels or similar wood-base products.

### Obtaining a Panel Similar to a Chipboard Panel

The panel is formed by placing a layer of the pressed laminar radicle sheet, at least one second layer of said pressed laminar sheet and at least one layer of adhesive between the layers of pressed laminar sheet; pressing with a hot press the panel formed from at least two layers of pressed laminar sheets; and leaving it to rest in a cold press for the stabilization thereof for at least 7 days, or

The panel can also be obtained by placing one layer of an unpressed laminar radicle sheet, at least a second layer of said unpressed laminar sheet and at least one layer of adhesive between the layers of unpressed laminar sheet, pressing with hot press the panel formed from at least two layers of unpressed laminar sheet and leaving it to rest for stabilization thereof for at least 7 days.

### Obtaining a Pressed Plywood Laminar Radicle Sheet

The pressed plywood laminar radicle sheet is formed with at least three layers: a first layer of any material and a last layer of any material, being the material of the last layer the same or a different one from the material of the first layer; and at least one layer of a pressed laminar radicle sheet placed between the first and last layer; and at least one layer of adhesive between the layers. The materials to be used can be rigid or flexible, for example, they can be selected from wood derivatives, plastic derivatives, glasses, metals, textiles, ceramics, and stones.

### Example for Obtaining a Pressed Laminar Radicle Sheet

The seeds were placed in appropriate trays for sowing, the dimensions of which are: 62 cm length, 41 cm width and 10 cm height and moved to a dark room for 3 days, being watered 2 times during 3 minutes each time. The germinated seeds were moved into the light, being watered 3 times a day every 8 hours. The duration of each watering was of 2 minutes and on the 13^{th} day; the leaf growth obtained was of 15 cm. The leaf growth was cut back until leaving only 1 cm height. The reticular mat was again moved into the light, being watered twice during the day, every 12 hours during two minutes per watering and on the 7^{th} day, the leaf growth obtained was of 12 cm. The dimensions of the obtained block were 60 cm length, 40 cm width and 25 cm height and with a weight of 5.5 kilos. The leaf growth was cut back, leaving it only 1 cm height. The reticular mat was dried leaving it to rest during 1 hour on a grid. Then, the reticular mat was put in a centrifuge for 3 minutes. The drying stage lasted 32 hours until reaching a 10% of moisture. The dried mat weighed 420 grams, measured 58 cm length, 34 cm width and 3 cm height.

According to the volume of the mat, 300 grams of adhesive were added, uniformly distributed on both faces of the reticular mat, ensuring that said adhesive penetrated the interstices of the reticular mat in the best possible way. Said mat was pressed with the adhesive in a cold press during 1 minute. In this way, an unpressed laminar radicle sheet was obtained.

The unpressed laminar radicle sheet was pressed with a hot press to a constant pressure of 5 tons and at a temperature of 70° C. for seven 7 minutes. Subsequently, it was left to rest in a cold press during 10 days. At the end of process, a pressed laminar radicle sheet was obtained, which is visually similar to chipboard having a thickness of 4.5 millimeters.

### Examples when Obtaining a Panel Containing a Pressed Laminar Radicle Sheet

### Example 1

The panel was formed by placing a layer of a pressed laminar radicle sheet, a layer of adhesive on said sheet, another layer of pressed laminar sheet, a second layer of adhesive and a third layer of pressed laminar sheet. Said panel was pressed with a hot press to a constant pressure of 5 tons, at a temperature of 70° C. for 7 minutes and it was left to rest in a cold press for 10 days.

### Example 2

The panel was formed by placing a layer of unpressed laminar radicle sheet, a layer of adhesive on said sheet, another layer of unpressed laminar sheet, a second layer of adhesive and a third layer of unpressed laminar sheet. Said panel was pressed with a hot press to a constant pressure of 5 tons, at a temperature of 70° C. for seven minutes and it was left to rest in a cold press for 10 days.

### Example to Obtain a Pressed Plywood Laminar Radicle Sheet

The pressed plywood laminar radicle sheet was formed from three layers: a first layer of plywood, a second layer of a pressed laminar radicle sheet and a third layer of plywood, and one layer of adhesive between the layers. Once the product was formed, it was pressed with a hot press to a constant pressure of 5 tons at a temperature of 70° C. for 7 minutes and it was left to rest in a cold press during 10 days.

1-13. (canceled)

14. A pressed laminar radicle sheet CHARACTERIZED in that said laminar sheet comprises an extended layer of a reticular mat, originating from a hydroponic seed culture and sufficient adhesive to form the laminar sheet; wherein said reticular mat is obtained through a procedure comprising:
a) Selecting, disinfecting, steeping, airing, sowing and germinating the seeds;
b) Producing a reticular component formed by a root mat and a low percentage of ungerminated seeds of at least 3 cm height and leaf component of at least 10 cm height;
c) Cutting the leaf growth, leaving only 1 to 1.5 cm of leaf growth on the reticular mat;
d) Allowing further leaf growth until reaching at least 10 cm height of leaf growth so as to decrease the percentage of ungerminated seeds;
e) Cutting the leaf growth back again, leaving only 1 to 1.5 cm of the leaf growth on the reticular mat;
f) Draining, drying and weighing and measuring the reticular mat.

15. A pressed laminar radicle sheet as claimed in claim 14 CHARACTERIZED in that the adhesive is selected from formaldehyde resins, preferably, from urea-formaldehyde resins.

16. A pressed laminar radicle sheet as claimed in claim 14 CHARACTERIZED in that in order to select the seeds to be used, the favored seeds are the ones presenting a fast radicle growth, and preferably the seeds are selected from the family Gramineae.

17. A pressed laminar radicle sheet as claimed in claim 16 CHARACTERIZED in that the possible Gramineae to be used are oats, wheat, barley or sorghum seeds.

18. A procedure for obtaining a pressed laminar radicle sheet as claimed in claim 14 CHARACTERIZED in that said procedure comprises:
a) Selecting, disinfecting, steeping, airing, sowing and germinating the seeds;
b) Producing a reticular component formed by a root mat and a low percentage of ungerminated seeds of at least 3 cm height and a leaf component of at least 10 cm height;
c) Cutting the leaf growth, leaving only 1 to 1.5 cm of leaf growth on the reticular mat;
d) Allowing further leaf growth until reaching at least 10 cm height of leaf growth so as to decrease the percentage of ungerminated seeds;
e) Cutting the leaf growth back again, leaving only 1 to 1.5 cm of the leaf growth on the reticular mat;
f) Draining, drying and weighing and measuring the reticular mat;
g) Forming the unpressed laminar radicle sheet, adding the adhesive to the reticular mat and pressing said mat with adhesive in a cold press for not more than one minute so as to promote the penetration of the adhesive within the sheet;
h) Pressing the unpressed laminar radicle sheet with a hot press and leaving it to rest in the cold press.

19. The procedure for obtaining a pressed laminar radicle sheet as claimed in claim 18 CHARACTERIZED in that the stage of airing the seeds comprises leaving the seeds in tins in a dark place during 24 to 72 hours, depending on the quality of the seed; and the stage of germinating the seeds which comprises moving seeds sowed in trays to a dark room to simulate the dark conditions of the soil, keeping them in this room for at least 2 days and watering them at least 1 time during this period. In this stage, if a bigger radicle growth is desired, it is advisable to provide a water stress period of 24 hours, which consists in not watering the seeds so as to induce a bigger radicle growth, since a state of drought is stimulated.

20. The procedure of obtaining a pressed laminar radicle sheet as claimed in claim 18 CHARACTERIZED in that during the production stage, the germinated seeds are moved into the light, watered 2 to 3 times a day, uniformly distributed during the day and with sufficient water to keep the moisture of the culture. This stage has an average duration of 8 to 15 days, depending on the development of the plant and the season of the year. In the case of the second production stage, stage d), the average duration thereof will be of 4 to 8 days.

21. The procedure of obtaining a pressed laminar radicle sheet as claimed in claim 18 CHARACTERIZED in that in order to drain the reticular mat, preferably this is left to rest on a grid for at least 1 hour so as this can naturally eliminate the water and possibly, this can also be centrifuged for at least 1 minute, because the reticular mat is slowly dried for at least 12 hours in order to achieve a reticular mat with approximately 10% of moisture, preferably 10% of moisture; and because the adhesive is applied to the reticular mat, ensuring that said adhesive penetrates the interstices of the reticular mat in the best possible way.

22. The procedure for obtaining a pressed laminar radicle sheet as claimed in claim 18 CHARACTERIZED in that the hot pressing is performed at a temperature of approximately 40° C. to 100° C. for at least 3 minutes and because the pressed laminar sheet is left to rest in a cold press for the stabilization thereof for at least 7 days.

23. The use of a pressed laminar radicle sheet as claimed in claim 14 CHARACTERIZED in that said sheet serves as a substitute for wood in the manufacture of panels, boards, laminar sheets and similar wood-based products.

24. A panel similar to a chipboard panel CHARACTERIZED in that said panel comprises a layer of pressed laminar radicle sheet, wherein said laminar sheet comprises an extended layer of a reticular mat originating from a hydroponic seed culture and sufficient adhesive to form a laminar sheet; and at least a second layer of said laminar sheet and at least one layer of adhesive between the layers of laminar sheet; and wherein said reticular mat is obtained through a procedure comprising:
a) Selecting, disinfecting, steeping, airing, sowing and germinating the seeds;
b) Producing a reticular component formed by a root mat and a low percentage of ungerminated seeds of at least 3 cm height and a leaf component of at least 10 cm height;
c) Cutting the leaf growth, leaving only 1 to 1.5 cm of leaf growth on the reticular mat;
d) Allowing further leaf growth until reaching at least 10 cm height of leaf growth so as to decrease the percentage of ungerminated seeds;
e) Cutting the leaf growth back again, leaving only 1 to 1.5 cm of the leaf growth on the reticular mat;
f) Draining, drying and weighing and measuring the reticular mat.

25. The procedure for manufacturing a panel similar to a chipboard panel as claimed in claim 24 CHARACTERIZED in that said procedure comprises:
a) Selecting, disinfecting, steeping, airing, sowing and germinating the seeds;
b) Producing a reticular component formed by a root mat and a low percentage of ungerminated seeds of at least 3 cm height and a leaf component of at least 10 cm height;
c) Cutting the leaf growth, leaving only 1 to 1.5 cm of leaf growth on the reticular mat;
d) Allowing further leaf growth until reaching at least 10 cm height of leaf growth so as to decrease the percentage of ungerminated seeds;
e) Cutting the leaf growth back again, leaving only 1 to 1.5 cm of the leaf growth on the reticular mat;
f) Draining, drying and weighing and measuring the reticular mat;
g) Forming the unpressed laminar radicle sheet, adding the adhesive to the reticular mat and pressing said mat with adhesive in a cold press for not more than one minute so as to promote the penetration of the adhesive within the sheet;
h) Pressing the unpressed laminar radicle sheet with a hot press and leaving it to rest in the cold press; and
i) Forming the panel by placing a layer of a pressed laminar radicle sheet and at least a second layer of said pressed laminar sheet; and at least one layer of adhesive between the layers of pressed laminar sheet, pressing with a hot press the panel formed from at least two layers of pressed laminar sheets and leaving it to rest for the stabilization thereof for at least 7 days.

26. A pressed plywood laminar radicle sheet CHARACTERIZED in that said sheet comprises at least one layer of a pressed laminar radicle sheet, wherein said laminar sheet comprises an extended layer of a reticular mat, originating from a hydroponic seed culture and sufficient adhesive to form the laminar sheet; at least two layers of any material and at least one layer of adhesive between the layers, being the at least one layer of pressed laminar radicle sheet placed between the layers of some other material; and wherein said reticular mat is obtained through a procedure which comprises:
a) Selecting, disinfecting, steeping, airing, sowing and germinating the seeds;
b) Producing a reticular component formed by a root mat and a low percentage of ungerminated seeds of at least 3 cm height and a leaf component of at least 10 cm height;
c) Cutting the leaf growth, leaving only 1 to 1.5 cm of leaf growth on the reticular mat;
d) Allowing further leaf growth until reaching at least 10 cm height of leaf growth so as to decrease the percentage of ungerminated seeds;
e) Cutting the leaf growth back again, leaving only 1 to 1.5 cm of the leaf growth on the reticular mat; and
f) Draining, drying and weighing and measuring the reticular mat.
